(19) United States
(12) Patent Application Publication
(10) Pub. No.: US 2024/0327011 A1
(43) Pub. Date: Oct. 3, 2024

(54) ADAPTIVE AIRCRAFT POWER MANAGEMENT SYSTEM

(71) Applicant: NORTHROP GRUMMAN SYSTEMS CORPORATION, FALLS CHURCH, VA (US)

(72) Inventor: Donald Stephens, Palm Bay, FL (US)

(21) Appl. No.: 18/190,545

(22) Filed: Mar. 27, 2023

(51) Int. Cl. B64D 31/00; B64D 41/00

(52) U.S. Cl. CPC B64D 31/00; B64D 41/00

(57) ABSTRACT

A system and method for selectively suspending the operation of aircraft systems based on prioritized system criticality in response to a high power demand from an aircraft engine. The method includes determining that a power demand on the aircraft engine will exceed a predetermined power limit, transmitting a suspend command to one or more of the aircraft systems in response to determining that the power demand on the aircraft engine will exceed the predetermined power limit, and causing the aircraft systems that receive the suspend command to enter a reduced power mode and not operate. The method also includes determining that the power demand on the one or more aircraft engines has been reduced below the predetermined power limit, and removing the suspend command and allow the aircraft systems that received the suspend command to operate as they were before receiving the suspend command.

### BACKGROUND

### Field

This disclosure relates generally to a system and method for providing aircraft power management and, more particularly, to a system and method for selectively suspending the operation of aircraft systems based on prioritized system criticality in response to a high power demand from the aircraft engines and subsystems.

### Discussion of the Related Art

Power is provided on an aircraft by one or more aircraft engines, which is a finite resource. Aircraft include several systems and subsystems, for example, electrical systems and hydraulic systems, that draw power from an engine gearbox coupled to the engine. Engine manufactures allow for a marginal amount of power to be utilized from the engine gearbox, such as 10-20% of the total engine power. Competing systems attached to the gear box are the electrical power system and hydraulics system. The combined power extractions by the electrical and hydraulic systems during high power demand can easily exceed the allocated amount of power at the gearbox. This can negatively impact the range of the aircraft and the reliability of the engine and gearbox. Other drawbacks include the potential for stalling the engine or damaging the gearbox. Historically, maintaining power extraction limits meant turning aircraft systems off. However, when an aircraft system is turned back on after the power demand is reduced the start-up time for the system may be excessive. These long start-up times often drive operators to turn systems on and leave them on.

### SUMMARY

The following discussion discloses and describes a system and method for selectively suspending the operation of aircraft systems based on prioritized system criticality in response to a high power demand from one or more aircraft engines, where the aircraft systems include aircraft systems that have mission critical functions, aircraft systems that have flight critical functions, and aircraft systems that have non-essential functions. The method includes determining that a power demand on the one or more aircraft engines will exceed a predetermined power limit, transmitting a suspend command to one or more of the aircraft systems that have mission critical functions that are not currently operational and aircraft systems that have non-essential functions if it is determined that the power demand on the one or more aircraft engines will exceed the predetermined power limit, and causing the aircraft systems that receive the suspend command to enter a reduced power mode and not operate. The method further includes determining that the power demand on the one or more aircraft engines has been reduced below the predetermined power limit, and removing the suspend command and allow the aircraft systems that received the suspend command to operate as they were before receiving the suspend command.

Additional features of the disclosure will become apparent from the following description and appended claims, taken in conjunction with the accompanying drawings.

### BRIEF DESCRIPTION OF THE DRAWINGS

FIG. 1 is an isometric view of a military type aircraft illustrating various aircraft systems;

FIG. 2 is a schematic block diagram of an adaptive aircraft power management system; and

FIG. 3 is a flow chart diagram showing a general process for suspending the aircraft systems based on prioritized system criticality in response to a high power demand from the aircraft engines.

### DETAILED DESCRIPTION OF THE EMBODIMENTS

The following discussion of the embodiments of the disclosure directed to a system and method for selectively suspending the operation of aircraft systems based on prioritized system criticality in response to a high power demand from the aircraft engines is merely exemplary in nature, and is in no way intended to limit the disclosure or its applications or uses.

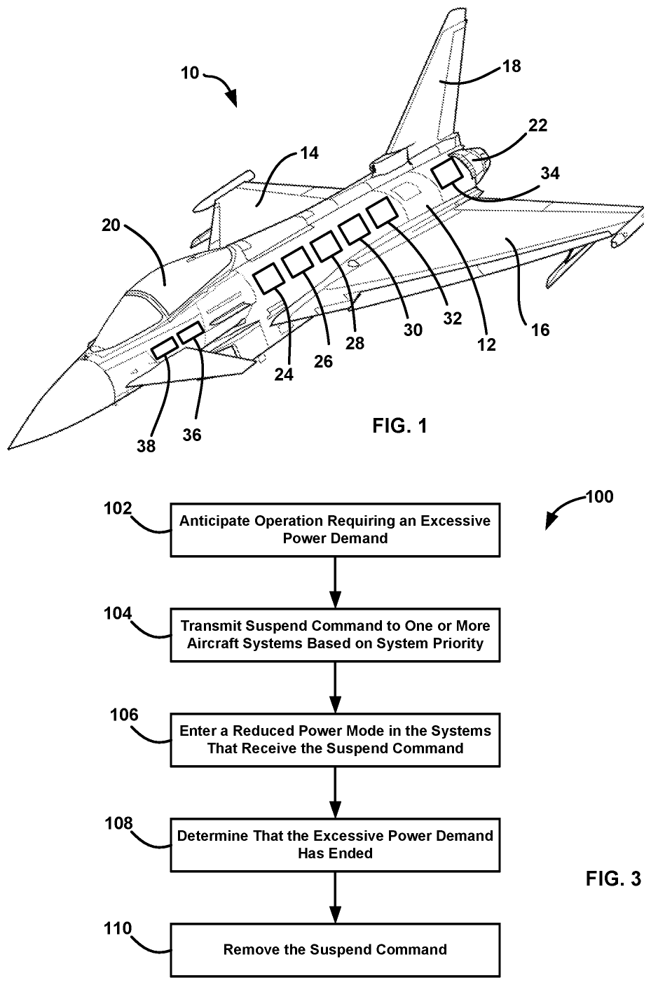

FIG. 1 is an isometric view of a military type aircraft 10 that includes a fuselage 12, wings 14 and 16, a tail 18, a cockpit 20 and an engine 22, where the aircraft 10 is intended to represent any aircraft that can benefit from the discussion herein. The aircraft 10 also includes a number of aircraft systems and subsystems that typically fall into three basic categories, namely, systems that provide flight critical functions, mission critical functions and non-essential functions. Those systems and subsystems include, but are not limited to, a fuel system 24, an aerodynamic system 26, a hydraulics system 28, an environmental control system (ECS) 30, a propulsion system 32 and a vehicle management system (VMS) 34. The aircraft 10 also includes non-essential loads 36, such as lighting, that are not required to keep the aircraft 10 flying and a gearbox 38 that reduces or controls the rotational speed of the aircraft engine 22. The operation of these systems and subsystems and other systems and subsystems on the aircraft 10 is well understood by those skilled in the art.

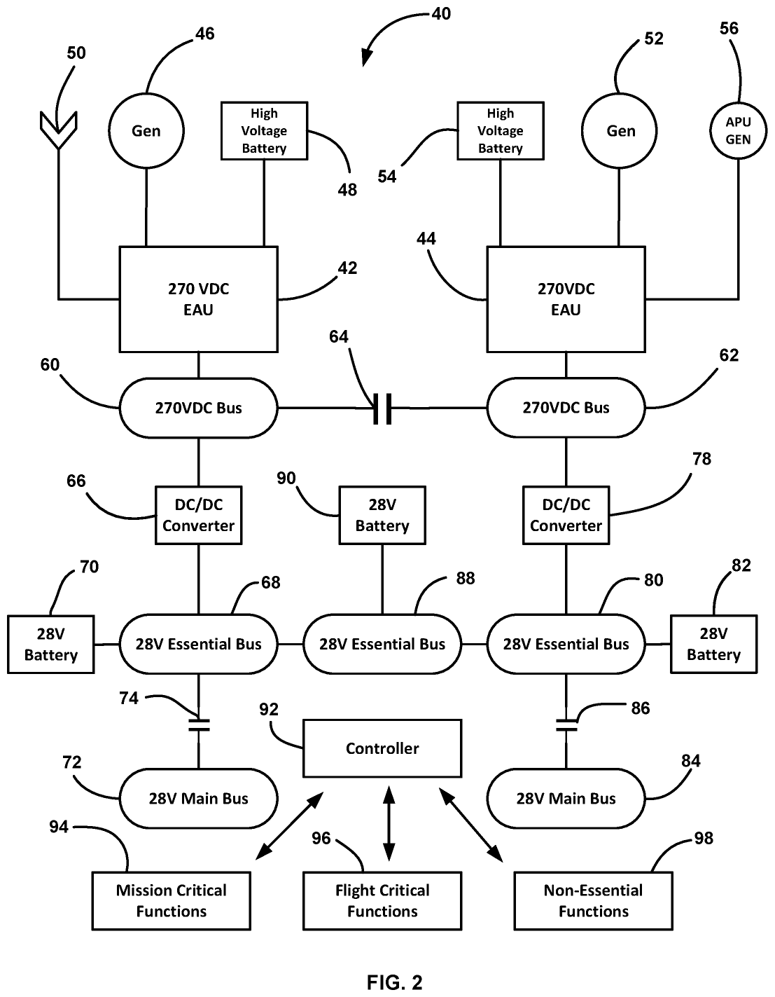

FIG. 2 is a schematic block diagram of an adaptive aircraft power management system 40 for a two engine aircraft, which can also be employed on the single engine aircraft 10 shown in FIG. 1, where the system 40 may be operating in the VMS 34. The system 40 includes two 270 VDC electrical accumulator units (EAUs) 42 and 44 that provide regulated electrical power for the systems 24-32. The system 40 also includes a generator 46 that generates electrical power from the torque provided by one of the engines and provides that power to the EAU 42. A high voltage battery 48 also provides power to the EAU 42 and is charged by the EAU 42 when the generator 46 provides more power than is needed by the aircraft systems 24-32. An auxiliary power source 50 external to the aircraft 10, such as a power source on an aircraft carrier, may at certain times provide power to the EAU 42 when the aircraft 10 is not flying. Likewise, the system 40 includes a generator 52 that generates electrical power from the torque provided by the turbine of the other engine and provides that power to the EAU 44. A high voltage battery 54 also provides power to the EAU 44 and is charged by the EAU 44 when the generator 52 provides more power than is needed by the aircraft systems 24-32. An auxiliary power unit (APU) generator 56 may provide power to the EAU 44 to operate the aircraft systems and systems other than the propulsion system 32.

The EAU 42 provides power to a 270 VDC bus 60 and the EAU 44 provides power to a 270 VDC bus 62 that are separated by a switch 64 to provide power to the aircraft systems and subsystems that operate on 270 volts. A DC/DC converter 66 converts the 270 volt DC power on the bus 60 to 28 volts and provides that power to a 28 volt essential bus 68, which also receives 28 volt power from a 28 volt battery 70. The bus 68 is coupled to a 28 volt main bus 72 through a switch 74, where 28 volt loads on the aircraft 10 can draw power from the buses 68 and 72. Likewise, a DC/DC converter 78 converts the 270 volt DC power on the bus 62 to 28 volts and provides that power to a 28 volt essential bus 80, which also receives 28 volt power from a 28 volt battery 82. The bus 80 is coupled to a 28 volt main bus 84 through a switch 86, where 28 volt loads on the aircraft 10 can draw power from the buses 80 and 84. Another 28 volt essential bus 88 is coupled to the buses 68 and 80, which also receives power from a 28 volt battery 90, where 28 volt loads on the aircraft 10 can draw power from the bus 88. A controller 92 is a general representation of all of the controllers and processors that control the various systems and subsystems on the aircraft 10 including systems and subsystems that have mission critical functions at box 94, systems and subsystems that have flight critical functions at box 96, and systems and subsystems that have non-essential functions at box 98.

The amount of torque that the engines can provide to the generators 46 and 52 through the gearbox 34 is limited. If more power is needed to meet aircraft power demands than what can be provided by the generators 46 and 52, then the batteries 48 and 54 can provide additional power. However, there still may be times that the power demand exceeds the maximum power that can be provided by the EAUs 42 and 44. The systems 24-32 include an additional integrated power operating mode, referred to herein as a Suspend mode, that allows for the aircraft systems, subsystems and/or other components to be selectively paused in operation and enter a low power mode as commanded by the VMS 34. In other words, the system 40 prioritizes flight critical and active mission critical functions over non-active mission critical functions and non-essential functions, and selectively puts systems and subsystems in the Suspend mode depending on the power demand. Further, depending on the how much the power demand is greater than a certain maximum power limit, the system 40 can prioritize which of the non-active mission critical functions and non-essential functions will receive the Suspend command. Once the aircraft power demands have been satisfied, the VMS 34 can remove the Suspend command on the systems, subsystems and components and allow them to continue their normal operation before the Suspend command was sent.

For example, if the aircraft 10 performs a maneuver that causes an extreme load in the hydraulic system 28, the VMS 34 will detect the onset of the maneuver and within 50 msec broadcast a Suspend command to one or more of the systems 24-32. Mission critical loads that are not in use and the non-essential aircraft loads 36 would enter a non-operational mode and remain in that mode until the maneuver is complete and the VMS 34 removes the Suspend command. Then the suspended systems and subsystems would resume operation. The impact at the engine gearbox 38 would be a quick reduction of power demands from the electrical power system corresponding with the increased power demand from the hydraulic system 28. This would ease the demands on the gearbox 34 and allow the engine 22 to provide power to both the electrical and hydraulic systems in extreme cases. Additional improvements can be incorporated to both the electrical and hydraulic systems to better support the system 40 with accumulators being implemented in both the electrical and hydraulic systems to help with peak power shaving.

As discussed above, the system 40 operates to better utilize existing power extraction capabilities of the engine by modifying the aircraft systems to better schedule power to flight critical functions and allow systems and subsystems to be suspended to reduce extraction under peak load conditions. By suspending the select systems during high hydraulic or electrical demands depending on operating conditions greater utilization of available power can occur. Suspended systems will be allowed to resume once the demand is lowered or the system is needed and other subsystems can be suspended. The systems that are suspended do not turn off, but pause their processing or operation and go into a low power demand state. The systems will maintain the power state and then recover seamlessly once the demand and operating conditions allow.

FIG. 3 is a flow chart diagram 100 showing a general process for selectively suspending the aircraft systems and subsystems based on priority in response to a high power demand from the aircraft engines as discussed above. The VMS 34 will detect an aircraft operation that will require an excessive power demand at box 102 that could cause the power available from the aircraft engines to be exceeded. The VMS 34 will transmit a Suspend command at box 104 to certain ones of the aircraft systems and subsystems based on a priority schedule if the system or subsystem operates a non-essential function or is a mission critical function that is currently not operating. The aircraft systems and subsystems that receive the Suspend command will go into a lower power mode at box 106 so that they do not draw power during the Suspend command. The VMS 34 will detect that the aircraft operation that required the excessive power demand has ended at box 108 and will remove the Suspend command at box 110 so that those aircraft systems and subsystems that received the Suspend command can immediately operate normally.

In various embodiments, the system 40 can operate on one or more of the following rules and assumptions. Aircraft engine horsepower extraction at the airframe mounted accessory drive (AMAD) or gearbox is finite. Accessories driven by the gearbox 34 have the capability to draw 80% of available power extraction. Priority for power extraction includes separating hydraulic flight control surfaces into flight critical and mission critical surfaces, mission critical loads fail safe or suspend operation safe, and non-essential loads fail safe or suspend operation safe. Bleed air extraction is not involved, but should be controlled to provide maximum power. Hydraulic and electrical system implement accumulators are employed to help smooth transients on gearbox power extraction. Auxiliary/non-essential functions potentially only utilize accumulator stored energy. Pilot/operator selected operating modes required to prioritize/limit systems. All modes must be designated, where no combination modes allowed. Future control actuation system (FCAS), VMS, hydraulics, electrical power system (EPS) and propulsion coordinate to determine base power extraction limits and available. Engine speed, altitude and thrust output limit available power across flight regime. Aircraft electrical power is stored, conditioned, distributed by the EAUs 42 and 44, where the generators 46 and 52 do not directly tie to the aircraft systems 24-32, a slew rate of OW to full load within 5 msec, and the EAUs 42 and 44 are sized to support 5 second and 5 minute overload ratings of 150% and 125%, respectively. Aircraft load shedding is now a global function affecting both the electrical and hydraulic systems. An aircraft line replaceable unit (LRU) design includes suspended/low power mode that can be commanded by the VMS 34 and executed within 50 msec of a command receipt.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A control system for selectively suspending the operation of aircraft systems based on prioritized system criticality in response to a high power demand from one or more aircraft engines, said control system comprising:
a controller including at least one processor storing data and executable code that, when executed, causes the at least one processor to:
determine that a power demand on the one or more aircraft engines will exceed a predetermined power limit;
transmit a suspend command to one or more of the aircraft systems in response to the determination that the power demand on the one or more aircraft engines will exceed the predetermined power limit that causes the aircraft systems that receive the suspend command to enter a reduced power mode and not operate;
determine that the power demand on the one or more aircraft engines has been reduced below the predetermined power limit; and
remove the suspend command and allow the aircraft systems that received the suspend command to operate as they were before receiving the suspend command.

2. The control system according to claim 1 wherein the aircraft systems include aircraft systems that have mission critical functions, aircraft systems that have flight critical functions, and aircraft systems that have non-essential functions, and wherein the at least one processor transmits the suspend command only to aircraft systems that have mission critical functions that are not currently operational and aircraft systems that have non-essential functions.

3. The control system according to claim 2 wherein the at least one processor prioritizes which aircraft systems that have mission critical functions that are not currently operational and aircraft systems that have non-essential functions will receive the suspend command based on how much power is being demanded.

4. The control system according to claim 2 wherein the aircraft systems that have flight critical functions include hydraulic systems.

5. The control system according to claim 1 wherein the suspend command is transmitted within 50 msec of determining that the power demand will exceed the power limit.

6. The control system according to claim 1 wherein the aircraft systems include a fuel system, an aerodynamic system, a hydraulics system, an environmental control system (ECS) and a propulsion system.

7. The control system according to claim 1 wherein the aircraft includes an electrical accumulator unit (EAU) for each engine that provides regulated electrical power for the aircraft systems, each EAU receiving power from the engine and a battery.

8. A method for selectively suspending the operation of aircraft systems based on prioritized system criticality in response to a high power demand from one or more aircraft engines, said method comprising:
determining that a power demand on the one or more aircraft engines will exceed a predetermined power limit;
transmitting a suspend command to one or more of the aircraft systems in response to determining that the power demand on the one or more aircraft engines will exceed the predetermined power limit;
causing the aircraft systems that receive the suspend command to enter a reduced power mode and not operate;
determining that the power demand on the one or more aircraft engines has been reduced below the predetermined power limit; and
removing the suspend command and allow the aircraft systems that received the suspend command to operate as they were before receiving the suspend command.

9. The method according to claim 8 wherein the aircraft systems include aircraft systems that have mission critical functions, aircraft systems that have flight critical functions, and aircraft systems that have non-essential functions, and wherein transmitting the suspend command includes only transmitting the suspend command to aircraft systems that have mission critical functions that are not currently operational and aircraft systems that have non-essential functions.

10. The method according to claim 9 wherein transmitting the suspend command includes prioritizing which aircraft systems that have mission critical functions that are not currently operational and aircraft systems that have non-essential functions will receive the suspend command based on how much power is being demanded.

11. The method according to claim 9 wherein the aircraft systems that have flight critical functions include hydraulic systems.

12. The method according to claim 8 wherein the suspend command is transmitted within 50 msec of determining that the power demand will exceed the power limit.

13. The method according to claim 8 wherein the aircraft systems include a fuel system, an aerodynamic system, a hydraulics system, an environmental control system (ECS) and a propulsion system.

14. The method according to claim 8 wherein the aircraft includes an electrical accumulator unit (EAU) for each engine that provides regulated electrical power for the aircraft systems, each EAU receiving power from the engine and a battery.

15. A method for selectively suspending the operation of aircraft systems based on prioritized system criticality in response to a high power demand from one or more aircraft engines, wherein the aircraft systems include aircraft systems that have mission critical functions, aircraft systems that have flight critical functions, and aircraft systems that have non-essential functions, said method comprising:
determining that a power demand on the one or more aircraft engines will exceed a predetermined power limit;
transmitting a suspend command to one or more of the aircraft systems that have mission critical functions that are not currently operational and aircraft systems that have non-essential functions within 50 msec of determining that the power demand on the one or more aircraft engines will exceed the predetermined power limit;
causing the aircraft systems that receive the suspend command to enter a reduced power mode and not operate;
determining that the power demand on the one or more aircraft engines has been reduced below the predetermined power limit; and
removing the suspend command and allow the aircraft systems that received the suspend command to operate as they were before receiving the suspend command.

16. The method according to claim 15 wherein transmitting the suspend command includes prioritizing which aircraft systems that have mission critical functions that are not currently operational and aircraft systems that have non-essential functions will receive the suspend command based on how much power is being demanded.

17. The method according to claim 15 wherein the aircraft systems that have flight critical functions include hydraulic systems.

18. The method according to claim 15 wherein the aircraft systems include a fuel system, an aerodynamic system, a hydraulics system, an environmental control system (ECS) and a propulsion system.

19. The method according to claim 15 wherein the aircraft includes an electrical accumulator unit (EAU) for each engine that provides regulated electrical power for the aircraft systems, each EAU receiving power from the engine and a battery.
